(19) United States
(12) Patent Application Publication
(10) Pub. No.: US 2024/0430409 A1
(43) Pub. Date: Dec. 26, 2024

(54) METHOD AND APPARATUS FOR VIDEO CODING USING PALETTE MODE BASED ON PROXIMITY INFORMATION

(71) Applicants: HYUNDAI MOTOR COMPANY, SEOUL (KR); KIA CORPORATION, SEOUL (KR); KWANGWOON UNIVERSITY INDUSTRY-ACADEMIC COLLABORATION FOUNDATION, SEOUL (KR)

(72) Inventors: Dong Gyu Sim, Seoul (KR); Min Hun Lee, Uijeongbu-si (KR); Joo Hyung Byeon, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); KWANGWOON UNIVERSITY INDUSTRY-ACADEMIC COLLABORATION FOUNDATION, SEOUL (KR)

(21) Appl. No.: 18/825,577

(22) Filed: Sep. 5, 2024

Related U.S. Application Data
(63) Continuation of application No. PCT/KR2023/002983, filed on Mar. 3, 2023.

(30) Foreign Application Priority Data
Mar. 22, 2022 (KR) 10-2022-0035562
Mar. 2, 2023 (KR) 10-2023-0027858

(51) Int. Cl. H04N 19/105; H04N 19/176; H04N 19/186; H04N 19/46

(52) U.S. Cl. CPC H04N 19/105; H04N 19/176; H04N 19/186; H04N 19/46

(57) ABSTRACT

A video decoding device generates a palette table for the current block, derives an index map by using adjacent information of the current block, and reconstructs samples of the current block based on the index map and the palette table. The adjacent information of the current block includes a neighboring block vector of the current block or a template within a previously reconstructed neighboring region of the current block. The index map includes the current block's per-sample index which indicates an entry in the palette table with a color value corresponding to a sample of the current block.

### CROSS REFERENCE TO RELATED APPLICATIONS

This application is a continuation of International Application No. PCT/KR2023/002983 filed on Mar. 3, 2023, which claims priority to and the benefit of Korean Patent Application No. 10-2022-0035562 filed on Mar. 22, 2022, and Korean Patent Application No. 10-2023-0027858, filed on Mar. 2, 2023, the entire contents of each of which are incorporated herein by reference.

### TECHNICAL FIELD

The present disclosure relates to a video coding method and an apparatus using an adjacent information-based palette mode.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required. In particular, there is a need for more efficient encoding and decoding techniques for video of screen content such as animation and computer graphics.

### SUMMARY

The present disclosure seeks to provide a video coding method and an apparatus that utilize an adjacent information-based palette mode in predicting the current block to increase video coding efficiency and enhance video quality.

At least one aspect of the present disclosure provides a method performed by a video decoding device for reconstructing a current block. The method includes generating a palette table for the current block. The method also includes deriving an index map by using adjacent information of the current block. Here, the adjacent information includes a neighboring block vector of the current block or a template within a previously reconstructed neighboring region of the current block. The index map includes a per-sample index of the current block and the index indicates an entry in the palette table with a color value corresponding to a sample of the current block. The method also includes reconstructing samples of the current block based on the index map and the palette table.

Another aspect of the present disclosure provides a method performed by a video encoding device for encoding a current block. The method includes determining a palette table and deriving an index map according to a first method that uses adjacent information of the current block. Here, the adjacent information comprises a neighboring block vector of the current block or a template within a previously reconstructed neighboring region of the current block. The method also includes determining the palette table and deriving the index map according to a second method that uses samples within the current block. The method also includes selecting an optimal method between the first method and the second method. The method also includes encoding the palette table according to the optimal method.

Yet another aspect of the present disclosure provides a computer-readable recording medium storing a bitstream generated by a video encoding method. The video encoding method includes determining a palette table and deriving an index map according to a first method that uses adjacent information of a current block. Here, the adjacent information comprises a neighboring block vector of the current block or a template within a previously reconstructed neighboring region of the current block. The video encoding method also includes determining the palette table and deriving the index map according to a second method that uses samples within the current block. The video encoding method also includes selecting an optimal method between the first method and the second method. The video encoding method also includes encoding the palette table according to the optimal method.

As described above, the present disclosure provides a video coding method and an apparatus that utilize a adjacent information-based palette mode in predicting the current block. Thus, the video coding method and the apparatus increase video coding efficiency and enhance video quality.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a palette table.

FIG. 7 is a diagram illustrating the initialization of a palette prediction list when 1-CTU delay Wavefront Parallel Processing (WPP) is enabled, according to at least one embodiment of the present disclosure.

FIG. 8 is a diagram illustrating a configuration of a palette table, according to at least one embodiment of the present disclosure.

FIG. 9 is a diagram illustrating a palette table including escape symbols.

FIG. 10 is a diagram illustrating a scan per multiple line-based coefficient group, according to at least one embodiment of the present disclosure.

FIG. 11 is a diagram illustrating an index run encoding for a coefficient group, according to at least one embodiment of the present disclosure.

FIG. 12 is a diagram illustrating the derivation of an adjacent information-based index map, according to at least one embodiment of the present disclosure.

FIG. 13 is a diagram illustrating the locations of block vectors, according to at least one embodiment of the present disclosure.

FIG. 14 is a diagram illustrating the signaling of a difference value of values mapped to respective indices in a palette, according to at least one embodiment of the present disclosure.

FIG. 15 is a flowchart of a method performed by a video encoding device for encoding the current block by using a palette mode, according to at least one embodiment of the present disclosure.

FIG. 16 is a flowchart of a method performed by a video decoding device for decoding the current block using a palette mode, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

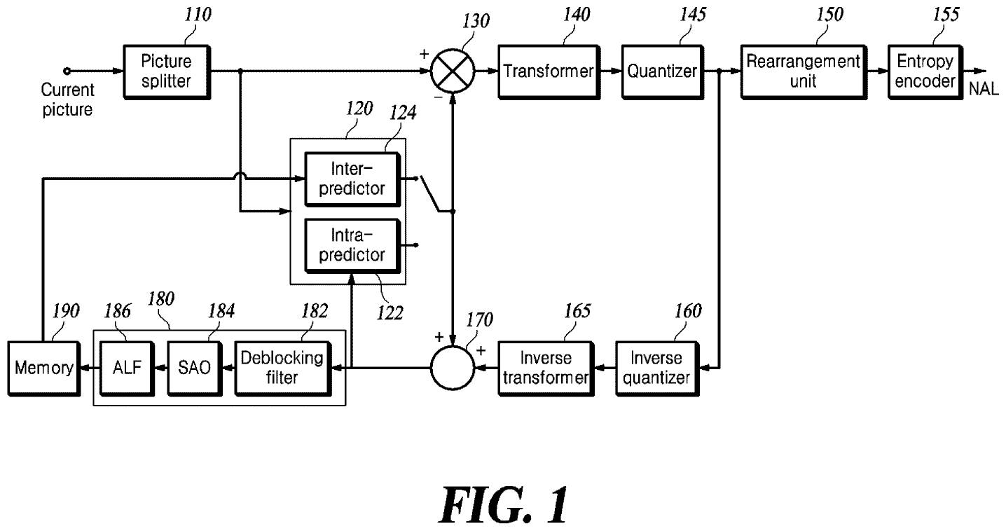

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

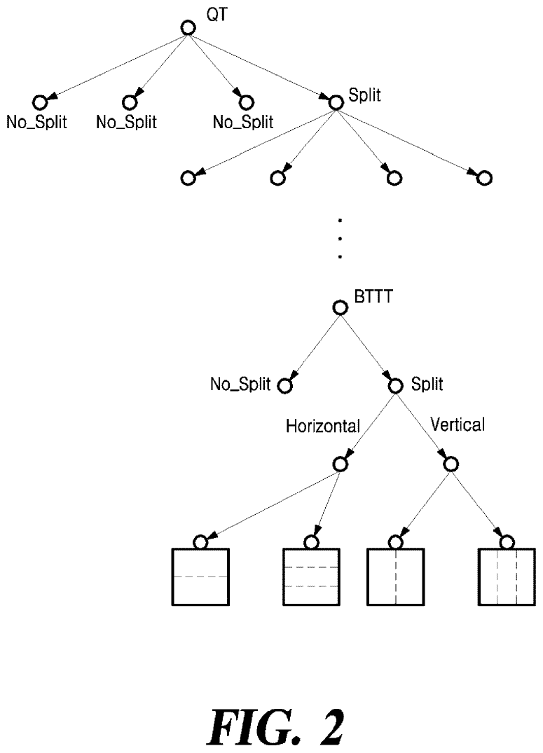

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

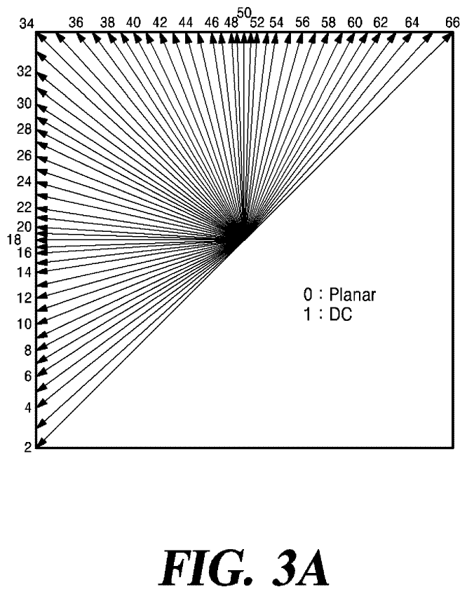

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

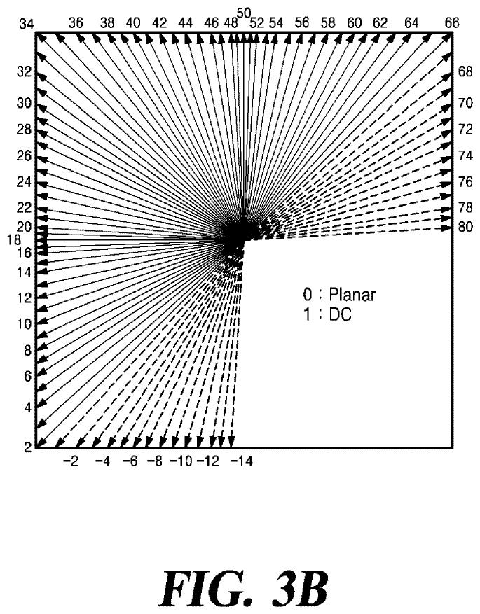

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

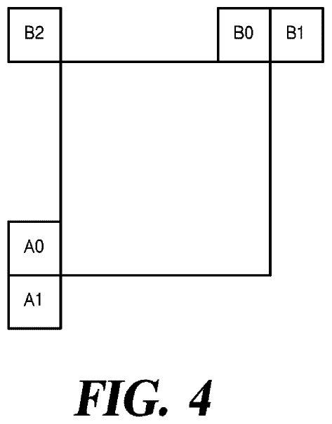

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that utilize an adjacent information-based palette mode in predicting the current block.

The following embodiments may be performed by the predictor 120 in the video encoding device. The following embodiments may also be performed by the predictor 540 in the video decoding device.

The video encoding device in the encoding of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with predicting the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I. Palette Mode

Palette mode may be applied when certain colors occur frequently in a video, such as a screen content video. In palette mode, the frequently occurring colors are stored in a table format. The video encoding device may transmit an index of the corresponding palette table to the video decoding device, and then the video decoding device may use the parsed index to predict the current block.

In one example, in palette mode, the video encoding device signals table information made by using the index for values of each pixel in the current block of size M×N that occur K (an integer greater than 1, where K≤M×N) or more times, and an index map for mapping to the palette table at each pixel position in the current block. The video decoding device may also parse the table information and the index map and may perform a prediction process to reconstruct the current block. In this case, K may be defined as a fixed value set according to an agreement between the video encoding device and the video decoding device or may be adaptively predefined according to the size of the current block.

The palette mode may apply to 4:4:4, 4:2:0, 4:2:2, and monochrome formats. When the palette mode is enabled, a flag may be sent at the CU level indicating activation of palette mode. The palette mode is applied to blocks 64×64 or smaller, but not applied to blocks containing 16 or fewer samples. The palette mode is considered to be a different prediction mode than intra prediction, inter prediction, and Intra Block Copy (IBC) modes. For example, if the prediction mode of the current block is palette mode, the reconstructed signals of the current block may be generated based on the prediction process with the transform process omitted.

On the other hand, in the case of a slice using a dual-tree with different CU splits between luma and chroma components, a palette may be used for each color component (e.g., Y palette, Cb palette, Cr palette), or two palettes may be used (e.g., Y palette, Cb/Cr palette). For a single tree, one palette may be used that contains all the color component (Y, Cb, Cr) values. For monochrome, a single palette may be used.

For slices using a single tree, the maximum size of the palette prediction list is 63, and the maximum size of the palette table for the current block is 31. For dual trees, the maximum size of the palette prediction list and the maximum size of the palette table are halved. Namely, for each luma palette and chroma palette, the maximum size of the palette prediction list is 31, and the maximum size of the palette table for the current block is 15. Additionally, depending on the color format, if the palette size for the luma component is P, the palette sizes for Cb and Cr may be P/2 each.

In one example, the size of the palette table may be predetermined based on the size of the current block according to an agreement between the video encoding device and the video decoding device. Alternatively, a fixed size of the palette may be predetermined regardless of the size of the current block.

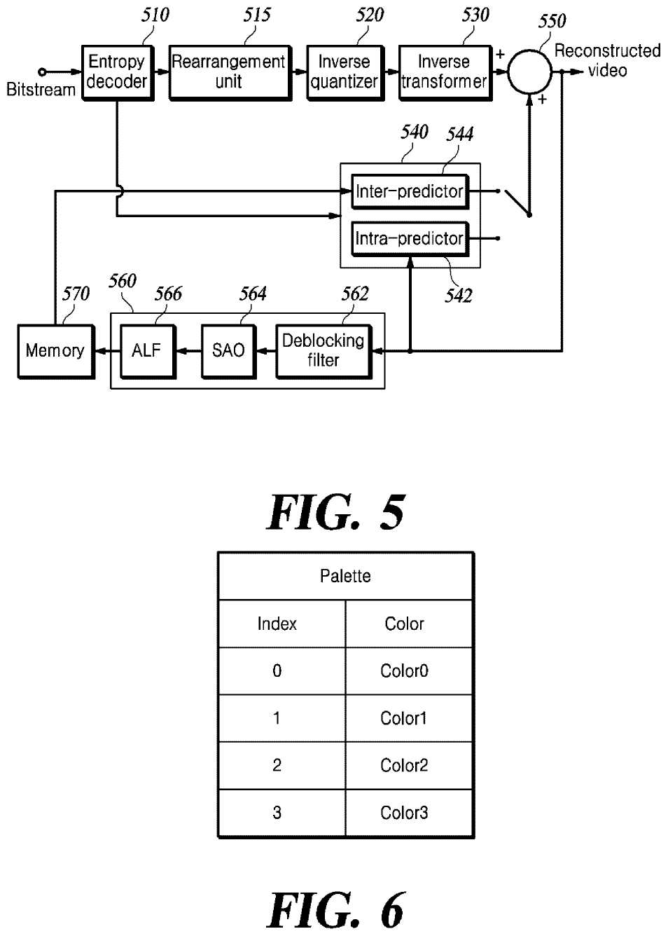

When palette mode is used, the samples in the current block may be represented by representative color values. Indices of the palette may be signaled for positions having sample values that are close to the palette colors. A palette table including the indices and corresponding colors may be configured as shown in the example of FIG. 6. The video encoding device may determine the palette table for the current block, for example, by applying clustering to the samples in the current block.

An entry represents a pair of index and color, as illustrated in FIG. 6.

To compose the palette table, a palette predictor or palette prediction list is maintained. The palette prediction list may have a maximum size that may be transmitted on SPS, and as described above, typically may has a size that is twice as large as the palette table.

Initializing a palette prediction list refers to the process of generating a palette prediction list for the first block of a group of video blocks (e.g., a picture, subpicture, slice, tile, and the like). Since no previous palette prediction list is available for the first block, the palette prediction list for the first block may be initialized to zero. Accordingly, the entries in the palette table for the first block may be new entries signaled by the video encoding device.

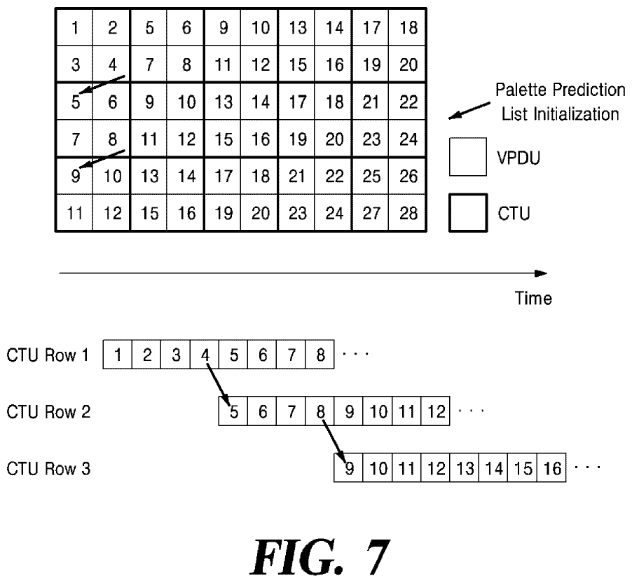

Additionally, when Wavefront Parallel Processing (WPP) is enabled, the palette prediction list may need to be initialized in the first CTU (or Virtual Pipeline Data Unit (VPDU)) of each CTU row to allow for parallel processing of the CTU rows. In this case, instead of initializing the palette prediction list to zero, the palette prediction list for the first CTU (or VPDU) of the current CTU row may be initialized by using palette data from an already decoded CTU or VPDU located at the top of the current CTU row. In other words, the palette prediction list of the already decoded CTU of the top CTU row may be used as the palette prediction list for the first CTU of the current CTU row. For example, as shown in the example of FIG. 7, when a 1-CTU delay WPP (i.e., a 4-VPDU delay WPP) is used, the palette prediction list for composing the palette table of the first CTU of the current CTU row may be initialized by using the palette prediction list of the last VPDU (i.e., the top CTU of the current CTU) that has already been decoded in the previous CTU row.

To reuse an entry included in the palette prediction list, the video encoding device may signal a flag indicating whether the entry is to be reused. If the corresponding flag is 1, the corresponding entry is reused in the current block's palette table (hereinafter used interchangeably with ‘current palette table’ or ‘current palette’), and if the corresponding flag is 0, the corresponding entry is not reused. The series of reuse flags (of 0 or 1 bins) for entries in the palette prediction list may be encoded by using run-length coding.

The video decoding device parses the series of reuse flags and stores in the current palette table those entries in the palette prediction list that are specified by the reuse flags. If the corresponding flag is 1, the video decoding device includes the corresponding entry in the current palette for reuse, and if the corresponding flag is 0, the corresponding entry is not reused.

Additionally, the remainder of the current palette table may be fulfilled by using one or more new entries that are explicitly transmitted from the video encoding device or implicitly determined by the video decoding device. In this case, one or more new entries may be added to the current palette table subsequent to the reused entries. If explicitly transmitted, the video encoding device may signal the number of new entries and their corresponding color values to the video decoding device. On the other hand, if all entries in the current palette are fulfilled by a series of reuse flags, encoding of the new entries may be omitted.

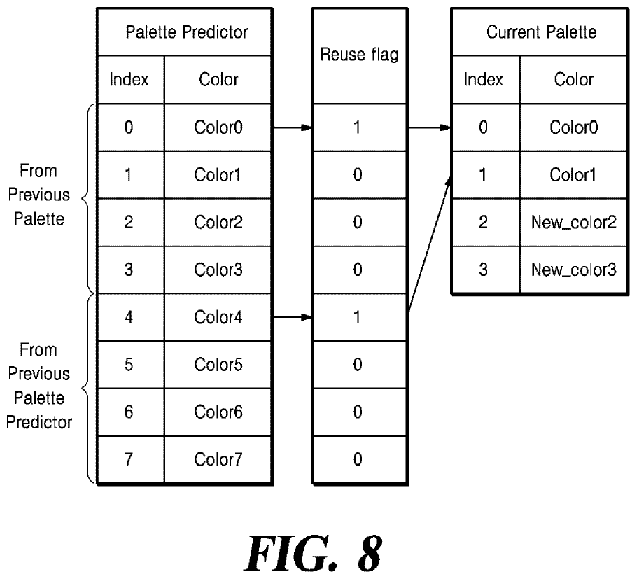

FIG. 8 is a diagram illustrating a configuration of a palette table, according to at least one embodiment of the present disclosure.

In the example of FIG. 8, the palette prediction list has eight entries and the current palette has four entries. A series of reuse flags indicates that the first and fifth entries of the palette prediction list (i.e., entries with indices 0 and 4) are included as the first and second entries of the current palette and that the remaining entries of the palette prediction list (i.e., entries corresponding to indices 1-3, 5-7) are not included in the current palette. It also indicates that new entries that are explicitly transmitted from the video encoding device or implicitly determined by the video decoding device are included as the third and fourth entries in the current palette.

After the current block is encoded by using the palette table, the video encoding device may update the palette prediction list. As illustrated in FIG. 8, the video encoding device updates the palette prediction list by using the current palette table. The video encoding device may then include any un-reused entries of the previous palette prediction list in the new palette prediction table until the maximum allowed size is reached. After the current block is decoded by using the palette table, the video decoding device may update the palette prediction list in the same manner as described above.

Any sample in the current block may not be identical or similar to any color contained in the palette. Such samples may not be suitable to be encoded based on the palette. Accordingly, an escape symbol may be signaled to identify samples that are outside the color range of the palette. First, the video encoding device may signal a flag to the video decoding device indicating whether any samples in the current block are to be encoded based on the escape symbol. This flag being zero indicates that no samples in the current block are encoded by using escape symbols. For example, all samples in the current block may be determined based on the entries contained in the palette table. On the other hand, this flag being 1 indicates that some samples in the current block are encoded by using escape symbols.

For samples in the current block that are encoded by using an escape symbol, the corresponding sample values may be quantized and sent directly to the video decoding device. If an escape symbol is present in the current block, the size of the palette table may be increased by one, and the last index in the table may be assigned to the escape symbol. Thus, the video encoding device may assign the last index of the palette table with the index increased by one to indicate that a particular sample of the current block is encoded with the escape symbol. If the index for a particular sample in the current block is the same as the index assigned to the escape symbol, the video decoding device may reconstruct the escape symbol by decoding the corresponding sample from the bitstream and then dequantizing the decoded corresponding sample.

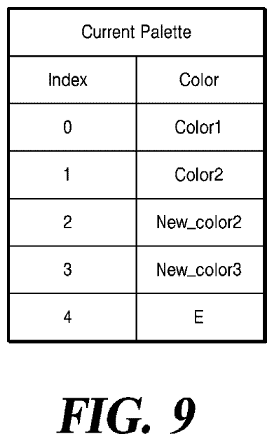

FIG. 9 is a diagram illustrating a palette table including escape symbols.

When the flag indicating whether a certain sample in the current block is to be encoded based on an escape symbol is 1, the last index of the corresponding palette table indicates the escape symbol, as shown in the example of FIG. 9. On the other hand, the video decoding device decodes the escape symbol for the sample indicated by the last index of the palette table, if the corresponding flag is 1, and then dequantizes the decoded escape symbol. This is equivalent to storing the dequantized escape sample at the end of the current palette table if the corresponding flag is 1.

After the palette table is generated, the video encoding device may generate an index map by determining an index for each sample of the current block being encoded according to the palette mode. For example, the video encoding device may derive the index map by using the palette table of the current block in terms of optimizing rate distortion. The video encoding device may then encode the index map by using index run encoding. In index run encoding, the current block is partitioned into multiple line-based coefficient groups, and index runs are generated for each coefficient group. The index runs are then signaled/parsed. Here, for example, a coefficient group may include 16 samples (m=16). In addition to the index runs, the indices of the palette table and quantized escape symbols are signaled/parsed per group.

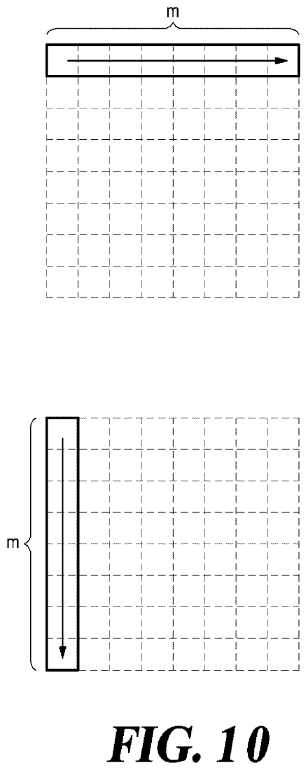

FIG. 10 is a diagram illustrating a scan per multiple line-based coefficient group, according to at least one embodiment of the present disclosure.

As illustrated in the example of FIG. 10, a horizontal or vertical traverse scan may be utilized to scan the samples of the current block. In the example of FIG. 10, m=8. The video encoding device may signal a flag indicating whether a horizontal traverse scan or a vertical traverse scan is utilized. If this flag is 0, the video decoding device may apply a horizontal transverse scan to the current block. On the other hand, if this flag is 1, the video decoding device may apply a vertical transverse scan to the current block.

For each coefficient group, the index run encoding may be performed as follows. For each sample position, a run_copy_flag may be signaled, which is a flag indicating whether the run type at the current position is identical to the run type of the previous scan sample. If this flag is 1, it indicates that the index run type at the current location is the same as the run type of the previous scan sample. Namely, the index run type at the current location and the run type of the previous scan sample may both be COPY_INDEX or COPY_ABOVE (or COPY_LEFT for vertical transverse scans).

On the other hand, this flag being zero indicates that the index run type at the current location is different from the run type of the previous scan sample. In this case, the copy_above_palette_indices_flag may be signaled, which is a flag indicating the run type at the current location. This flag of 1 indicates COPY_ABOVE (or COPY_LEFT for vertical traversal scans), meaning that the palette index at the current position is set to be the same as the palette index at the same position in the top row (or the same position in the left row for vertical traversal scans). On the other hand, this flag being 0 indicates COPY_INDEX. Namely, the palette index at the current position may be signaled or derived.

In the current block's first row (for horizontal traversal scans) or first column (for vertical traversal scans), the run type of the corresponding sample is by default COPY_INDEX and is therefore not signaled. Additionally, if the previously parsed run type is COPY_ABOVE, the run type at the current position is not signaled.

The index runs described above may include a flag indicating whether the run type at the current location is the same as the run type in the previous scan sample, and a flag of copy_above_palette_indices_flag indicating the run type at the current location.

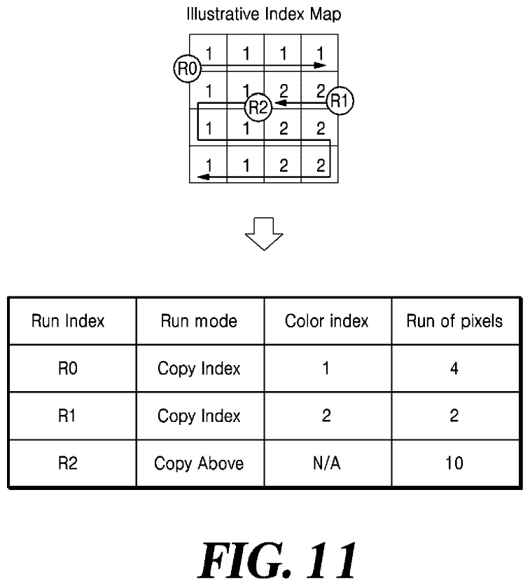

FIG. 11 is a diagram illustrating an index run encoding for a coefficient group, according to at least one embodiment of the present disclosure.

In the example of FIG. 11, for one coefficient group (m=16), an index map may be encoded based on the index run encoding. In the example of FIG. 11, three run types based on horizontal transverse scans are used, and the lengths of each run type are 4, 2, and 10 samples.

Based on the decoded index map and the current palette, the video decoding device may predict the value of each sample in the current block in palette mode. Namely, for each sample, an index is derived by using the index map, and the value of each sample may be predicted by using the color value indicated by the index in the current palette table.

### II. Adjacent Information-Based Palette Mode

As opposed to signaling/parsing an index run encoded index map, in one example, the palette table and index map of the current block may be derived based on adjacent information of the current block. Here, the adjacent information may be an block vector of the M×N current block, or information on previously reconstructed regions in the current frame based on template matching utilizing template regions around the current block.

In one example, a flag may be signaled indicating whether to derive an index map of the current block based on the adjacent information. If this flag is 1, the video decoding device may derive the index map of the current block based on the adjacent information of the current block. If the flag is 0, the video decoding device may decode an index run encoded index map, as shown in the example of FIG. 11.

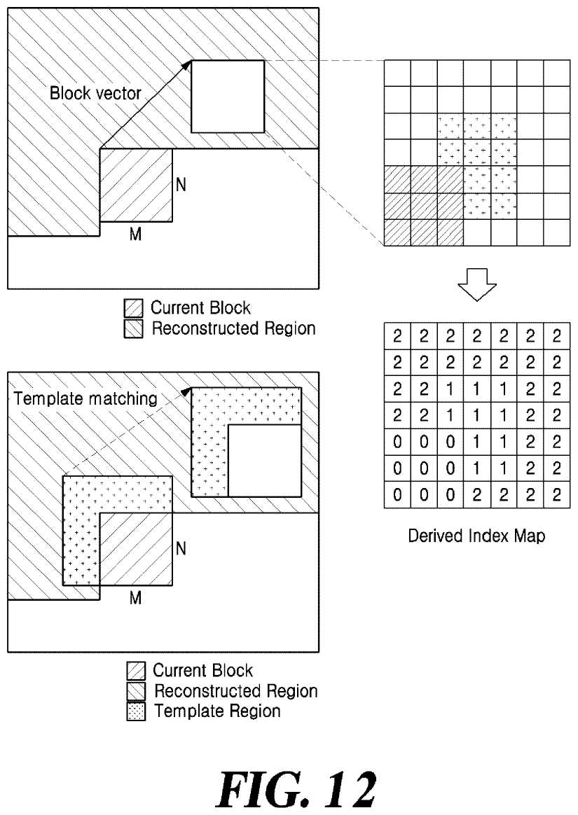

FIG. 12 is a diagram illustrating the derivation of an adjacent information-based index map, according to at least one embodiment of the present disclosure.

In one example, when an index map is derived based on template matching, as illustrated in FIG. 12, template matching is the process of finding an optimal cost value between a template in a previously reconstructed neighboring region of the current block and a neighboring template of a random reference block in a previously reconstructed region within the current frame. As a cost function, SAD (Sum of Absolute Difference), SATD (Sum of Absolute Transformed Difference), SSE (Sum of Squared Difference), and the like may be used. The block with the optimal cost among random reference blocks is set as a candidate block for deriving the index map.

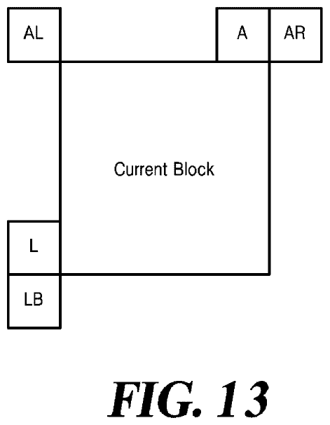

When block vectors are utilized, block vectors present at the left, top, top-left, top-right, and bottom-left positions of the current block may be utilized, as shown in the example of FIG. 13. At this time, the video encoding device and the video decoding device may configure the same block vector candidate list, and then may signal/parse the index of the selected block vector according to block matching. Block matching is the process of finding the optimal cost value between the current block and the reference block indicated by the block vector. In this case, SAD, SATD, SSE, and the like may be used as a cost function. Similarly, the block with the optimal cost among the random reference blocks is set as a candidate block to derive the index map.

As another example, without signaling and parsing, the video encoding device and the video decoding device may equally compose a block vector candidate list and then may perform template matching on each block vector candidate to derive a candidate block with an optimal cost value.

Alternatively, in the absence of additional signaling and parsed information, and when the block vector of the current block is not available, template matching may be performed on a previously reconstructed neighboring region of the current block to derive a candidate block with an optimal cost value, as shown in the example of FIG. 12.

As one example, to derive the palette table and index map from the previously reconstructed region, i.e., the candidate block, the video encoding device may use methods such as quantization, clustering, segmentation, and the like.

For example, when the palette table is determined by using quantization, the video encoding device may implicitly determine the quantization step (Q_step) based on the quantization parameter of the current block, or may implicitly determine the quantization step based on the reconstructed pixel values of the previously reconstructed region used for derivation. In this case, the number of quantization steps may be the size of the palette, which is the number of indices in the palette. The video encoding device may determine the palette table of the candidate block by quantizing the samples of the candidate block based on the quantization steps and deriving an entry in the palette corresponding to each quantized sample.

As another example, when clustering is used to determine the palette table, the size of the palette, which is the number of indices in the palette, may be implicitly determined by the number of clusters, which is the set to be clustered. The palette table of the candidate block may then be determined by performing clustering of the candidate block based on the number of clusters and deriving the palette entries corresponding to each cluster.

As another example, when segmentation is used to determine a palette table, the size of the palette, which is the number of indices in the palette, may be implicitly determined as the set to be segmented, i.e., the number of segments. Then, by performing the segmentation of the candidate block based on the number of segments, and deriving the entries of the palette corresponding to each segment, the palette table of the candidate block may be determined.

In the process of determining the palette table of the candidate block, the video encoding device may use an escape symbol to identify samples that are outside the color range of the palette. If an escape symbol is present in the candidate block, the video encoding device may increase the size of the palette table by one and may assign the last index in the table to the escape symbol.

The video encoding device may then use the palette table of the candidate block to derive an index map in terms of cost optimization. Here, cost represents the cost value between the candidate block and the reconstructed block generated by the index map. In this case, SAD, SATD, SSE, and the like may be utilized as a cost function.

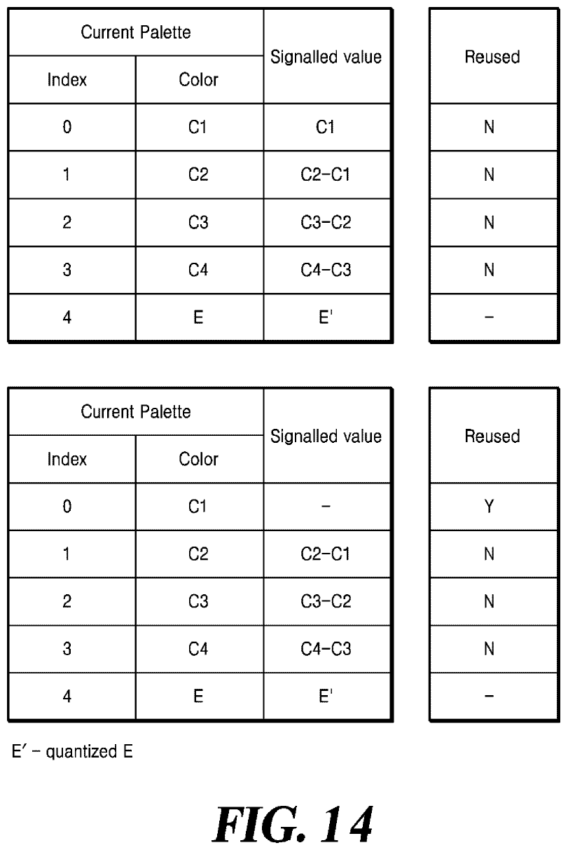

FIG. 14 is a diagram illustrating the signaling of a difference value of values mapped to respective indices in a palette, according to at least one embodiment of the present disclosure.

In one example, after a previously reconstructed region is selected in the current frame and an index map is derived from information on the region, when the magnitude of each index value in the derived index map is proportional to the magnitude of a pixel value in the selected previously reconstructed region and is proportional to a magnitude of a value mapped to each index in the palette, a difference value of values mapped to each index in the palette may be signaled for the new entries being signaled, as illustrated in FIG. 14. The video decoding device may reconstruct the palette by reconstructing the values that map to each index for the new entries and then adding the reconstructed difference values per index to the values that map to the previous index based on the first new entry. If the entry is a reused entry based on the reuse flag, the value that maps to the corresponding index may be derived from the palette prediction list and used for the current palette.

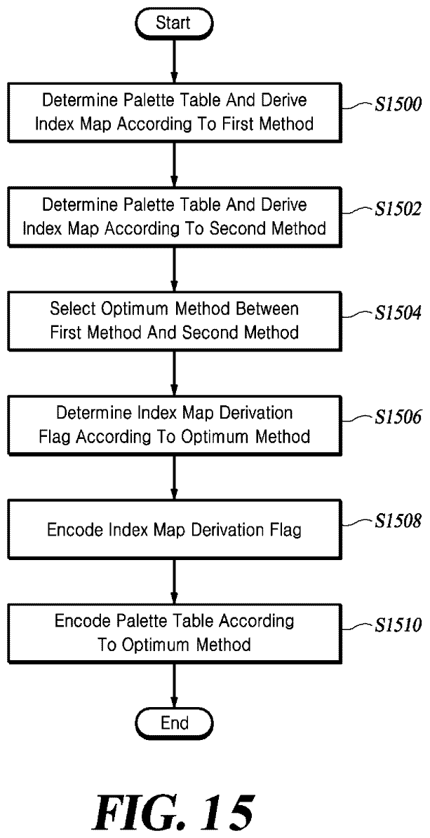

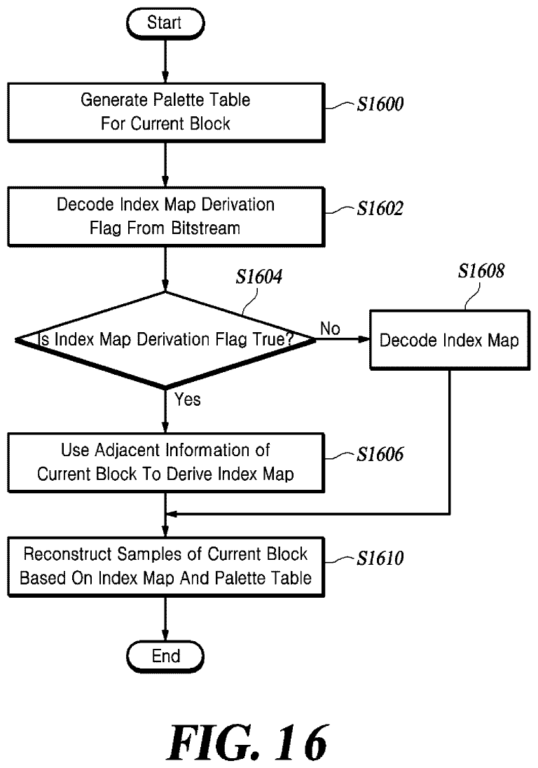

Referring now to FIGS. 15 and 16, methods of encoding/decoding a current block by using a adjacent information-based palette mode are described. In FIGS. 15 and 16, the palette mode is applied to the current block determined by a prediction unit (PU).

FIG. 15 is a flowchart of a method performed by a video encoding device for encoding the current block by using a palette mode, according to at least one embodiment of the present disclosure.

The video encoding device determines a palette table and derives an index map (S1500) according to the first method. Here, the first method uses adjacent information of the current block, and the adjacent information includes a block vector of neighbors of the current block or a template within a previously reconstructed neighboring region of the current block.

In the first method, the video encoding device generates a candidate block by using the adjacent information of the current block and then determines a palette table of the candidate block. The video encoding device then uses the palette table of the candidate block to derive an index map. Accordingly, the index map includes a per-sample index of the candidate block, and the index indicates an entry in the palette table of the candidate block with a color value corresponding to a sample of the candidate block.

As one example of generating a candidate block, the video encoding device composes a block vector candidate list by using block vectors present at the left, top, top-left, top-right, and bottom-left positions of the current block, as shown in the example of FIG. 13. The video encoding device may select an optimal block vector from the block vector candidate list by using block matching, and may generate the candidate block based on the selected block vector. The video encoding device may then encode an index of the selected block vector.

As another example, without further encoding, the video encoding device may apply template matching to the current block and the block indicated by each candidate block vector in the block vector candidate list to set the block with the optimal cost as the candidate block.

As another example, if there is no additional encoding and the block vector cannot be utilized, the video encoding device may apply template matching to a previously reconstructed neighboring region of the current block to set the block corresponding to the template with the optimal cost as the candidate block.

Meanwhile, the video encoding device may apply a palette table derivation method to the candidate block to determine a palette table. Here, the palette table derivation method may utilize quantization steps, clustering, or segmentation.

In one example, the video encoding device implicitly derives an optimal quantization step and then quantizes the samples of the candidate block based on the derived quantization step. The video encoding device may determine the palette table by deriving an entry in the palette table corresponding to each quantized sample.

As another example, the video encoding device determines a number of clusters for clustering, and clusters the candidate block based on the number of clusters. The video encoding device may then determine the palette table by deriving an entry in the palette table corresponding to each cluster.

As yet another example, the video encoding device determines a number of segments for segmentation, and segments the candidate block based on the number of segments. The video encoding device may then determine the palette table by deriving an entry in the palette table corresponding to each segment.

The video encoding device may use the palette table of the candidate block to derive an index map in terms of cost optimization. Here, cost indicates a cost value between the reconstructed block generated by the index map and the candidate block. In this case, SAD, SATD, SSE, and the like may be utilized as a cost function.

In determining the palette table of the candidate block, the video encoding device may use an escape symbol to identify samples that are outside the color range of the palette. If an escape symbol is present in the candidate block, the video encoding device may increase the size of the palette table by one, and may assign the last index in the table to the escape symbol.

The video encoding device determines the palette table according to the second method and derives an index map (S1502).

Here, the second method utilizes the samples in the current block. Namely, the video encoding device determines the palette table of the current block by using the samples of the current block and derives the index map by using the palette table of the current block. Thus, the index map includes a per-sample index of the current block, and the index indicates an entry in the palette table of a candidate block having a color value corresponding to the sample of the current block.

The video encoding device may determine the palette table of the current block, for example, by applying clustering to the samples of the current block.

In generating the palette table of the current block, the video encoding device may use escape symbols to identify samples that are outside the color range of the palette. If the escape symbol is present in the current block, the video encoding device may increase the size of the palette table by one and may assign the last index in the table to the escape symbol.

The video encoding device may use the palette table of the current block to derive the index map in terms of optimizing rate distortion.

The video encoding device may then encode the index map based on the index run encoding. Here, the index run encoding partitions the current block into multiple line-based coefficient groups and determines the index runs and corresponding indices per coefficient group.

The video encoding device selects an optimal method between the first method and the second method (S1504).

The video encoding device determines an index map derivation flag according to the optimal method (S1506). Here, the index map derivation flag indicates whether to derive the index map based on the first method utilizing the adjacent information of the current block.

The video encoding device encodes the index map derivation flag (S1508).

The video encoding device encodes the palette table according to the optimal method (S1510).

The video encoding device may set a series of reuse flags based on reused entries in the palette table from the palette prediction list. Further, the video encoding device may set the remaining entries in the palette table, other than the reused entries, as new entries.

The video encoding device encodes the series of reuse flags and encodes the new entries.

After the palette table is encoded, the video encoding device may update the palette prediction list. The video encoding device may include entries from the palette table in the palette prediction list. The video encoding device may also add un-reused entries from the previous palette prediction list to the palette prediction list until the maximum allowed size is reached.

FIG. 16 is a flowchart of a method performed by a video decoding device for decoding the current block by using a palette mode, according to at least one embodiment of the present disclosure.

The video decoding device generates a palette table for the current block (S1600).

To generate the palette table, the video decoding device first decodes a series of reuse flags from the bitstream. Here, the series of reuse flags indicates whether the entries in the palette prediction list are reused. The video decoding device includes in the palette table the reused entries from the palette prediction list based on the values of the series of reuse flags. Additionally, the video decoding device may first decode new entries from the bitstream or implicitly may derive the new entries and then may add the new entries to the palette table.

After the palette table is generated, the video decoding device may update the palette prediction list. The video decoding device includes entries from the palette table in the palette prediction list. The video decoding device may also add entries from the previous palette prediction list that are not reused to the palette prediction list until the maximum allowed size is reached.

The video decoding device decodes an index map derivation flag from the bitstream (S1602). Here, the index map derivation flag indicates whether to derive an index map based on the adjacent information of the current block.

The video decoding device checks the index map derivation flag (S1604).

If the index map derivation flag is true (Yes in S1604), the video decoding device derives an index map by using the adjacent information of the current block (S1606). Here, the index map includes a per-sample index of the current block, and the index indicates an entry in the palette table with a color value corresponding to a sample of the current block.

As adjacent information, the video decoding device may use a block vector of neighbors of the current block or a template within a previously reconstructed neighboring region of the current block. The video decoding device uses the adjacent information to generate a candidate block for deriving the index map.

In one example, the video decoding device composes a block vector candidate list by using block vectors present at the left, top, top-left, top-right, and bottom-left positions of the current block, as shown in the example of FIG. 13. Then, the video decoding device may decode the candidate index, and may generate a candidate block based on the block vectors derived from the block vector candidate list by using the candidate index.

As another example, without further parsing, the video decoding device may apply template matching to the current block and the block indicated by each candidate block vector in the block vector candidate list to set the block with the optimal cost as the candidate block.

As yet another example, if there is no additional parsing and the block vector cannot be utilized, the video decoding device may apply template matching to a previously reconstructed neighboring region of the current block to set the block corresponding to the template with the optimal cost as the candidate block.

The video decoding device may use the palette table to derive the index map of the candidate block in terms of cost optimization. Here, cost indicates a cost value between the reconstructed block generated by the index map and the candidate block. In this case, SAD, SATD, SSE, and the like may be utilized as a cost function.

On the other hand, if the index map derivation flag is false (No in S1604), the video decoding device decodes the index map based on index run decoding (S1608).

Here, the index run decoding partitions the current block into multiple line-based coefficient groups, and then decodes the index runs and corresponding indices from the bitstream per coefficient group.

The video decoding device reconstructs samples of the current block based on the index map and palette table (S1610).

If the index indicates the last entry in the palette table extended to support escape symbols, the video decoding device decodes the escape symbols from the bitstream. The video decoding device then dequantizes the decoded escape symbols.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for reconstructing a current block, the method comprising:
generating a palette table for the current block;
deriving an index map by using adjacent information of the current block, wherein the adjacent information comprises a neighboring block vector of the current block or a template within a previously reconstructed neighboring region of the current block, wherein the index map comprises an index by sample of the current block, and wherein the index indicates an entry in the palette table with a color value corresponding to a sample of the current block; and
reconstructing samples of the current block based on the index map and the palette table.

2. The method of claim 1, further comprising:
decoding from a bitstream an index map derivation flag that indicates whether to derive the index map based on the adjacent information; and
checking the index map derivation flag;
wherein, when the index map derivation flag is true, the method further comprises deriving the index map by using the adjacent information.

3. The method of claim 2, further comprising:
when the index map derivation flag is false, decoding the index map from the bitstream.

4. The method of claim 1, wherein generating the palette table comprises:
decoding from a bitstream a series of reuse flags that indicate whether entries included in a palette prediction list are to be reused; and
including reused entries from the palette prediction list in the palette table based on values of the series of reuse flags.

5. The method of claim 4, wherein generating the palette table comprises:
decoding new entries from the bitstream or implicitly deriving the new entries;
adding the new entries to the palette table; and
updating the palette prediction list.

6. The method of claim 1, wherein deriving the index map comprises:
generating a candidate block for deriving the index map; and
deriving an index map of the candidate block by using the palette table.

7. The method of claim 6, wherein generating the candidate block comprises:
composing a block vector candidate list by using block vectors present at left, top, top-left, top-right, and bottom-left positions of the current block;
decoding a candidate index; and
generating the candidate block, based on a block vector derived from the block vector candidate list by using the candidate index.

8. The method of claim 6, wherein generating the candidate block comprises:
composing a block vector candidate list by using block vectors present at left, top, top-left, top-right, and bottom-left positions of the current block; and
setting a block with an optimal cost as the candidate block by applying template matching to the current block and a block indicated by each candidate block vector of the block vector candidate list.

9. The method of claim 6, wherein generating the candidate block comprises:
setting a block corresponding to a template with an optimal cost as the candidate block by applying template matching to the previously reconstructed neighboring region of the current block.

10. The method of claim 6, wherein deriving the index map comprises:
deriving an index map of the candidate block in terms of cost optimization; and
setting the index map of the candidate block to the index map of the current block.

11. A method performed by a video encoding device for encoding a current block, the method comprising:
determining a palette table and deriving an index map according to a first method that uses adjacent information of the current block, wherein the adjacent information comprises a neighboring block vector of the current block or a template within a previously reconstructed neighboring region of the current block;
determining the palette table and deriving the index map according to a second method that uses samples within the current block;
selecting an optimal method between the first method and the second method; and
encoding the palette table according to the optimal method.

12. The method of claim 11, wherein the first method comprises:
generating a candidate block by using the adjacent information of the current block;
determining a palette table of the candidate block; and
deriving the index map by using the palette table of the candidate block in terms of cost optimization;
wherein the index map comprises a per-sample index of the candidate block; and
wherein the index indicates an entry in the palette table with a color value corresponding to a sample of the candidate block.

13. The method of claim 11, wherein the second method comprises:
determining a palette table of the current block by using the samples of the current block;
deriving the index map by using the palette table of the current block in terms of rate-distortion optimization; and
encoding the index map.

14. The method of claim 11, further comprising:
determining, based on the optimal method, an index map derivation flag that indicates whether to derive the index map based on the first method; and
encoding the index map derivation flag.

15. The method of claim 11, wherein encoding the palette table comprises:
setting a series of reuse flags based on reused entries in the palette table from a palette prediction list;
setting remaining entries in the palette table, excluding the reused entries, as new entries; and
updating the palette prediction list.

16. The method of claim 15, wherein encoding the palette table further comprises:
encoding the series of reuse flags; and
encoding the new entries.

17. The method of claim 12, wherein determining the palette table comprises:
determining the palette table by applying a method of derivation of the palette table to the candidate block, wherein the method of derivation utilizes a quantization step, clustering, or segmentation.

18. A computer-readable recording medium storing a bitstream generated by a video encoding method, the video encoding method comprising:
determining a palette table and deriving an index map according to a first method that uses adjacent information of a current block, wherein the adjacent information comprises a neighboring block vector of the current block or a template within a previously reconstructed neighboring region of the current block;
determining the palette table and deriving the index map according to a second method that uses samples within the current block;
selecting an optimal method between the first method and the second method; and
encoding the palette table according to the optimal method.
